(19) United States
(12) Patent Application Publication
(10) Pub. No.: US 2007/0190950 A1
(43) Pub. Date: Aug. 16, 2007

(54) METHOD OF CONFIGURING VOICE AND DATA COMMUNICATION OVER A VOICE CHANNEL

(75) Inventors: Sethu K. Madhavan, Canton, MI (US); Ki Hak Yi, Windsor, Ontario (CA)

Correspondence Address: General Motors Corporation;c/o REISING, ETHINGTON, BARNES, KISSELLE, P.C., P.O. BOX 4390, TROY, MI, 48099-4390, US

(73) Assignee: GENERAL MOTORS CORPORATION, Detroit, MI (US)

(21) Appl. No.: 11/307,637

(22) Filed: Feb. 15, 2006

(51) Int. Cl. H04B 1/034

(52) U.S. Cl. 455/99

(57) ABSTRACT

A method for configuring voice and data communication over a voice channel of a wireless telecommunications network that includes an onboard vehicle communications system, a cell tower, a base station, a Public Switched Telephone Network (PSTN) and a remote call center. Initially, a component on the network side, such as a network vocoder incorporated within a base station, selects a data rate during configuration of the voice channel. Thereafter, an onboard vocoder incorporated within a chipset of the onboard vehicle communications system sends a service option control message to the network vocoder requesting a higher data rate for the subsequent voice and data transmissions. A similar process occurs during a handoff that involves a change of network vocoders.

### TECHNICAL FIELD

The present invention generally relates to voice and data communication between an onboard vehicle communications system and a remote call center and, more particularly, to voice and data communication over a voice channel of a wireless telecommunications network.

### BACKGROUND OF THE INVENTION

Wired telephone systems were originally designed to carry speech to enable voice conversations over long distances. More recently, Public Switched Telephone Networks (PSTNs) have become a primary medium for transmitting not only voice, but also non-speech data such as that used by facsimile machines to transmit image information over the telephone lines, or by modems that exchange digital data of various forms (text, binary executable files, image or video files) over these same phone lines.

Today, cellular and other wireless telecommunication systems are in much greater use for purposes of both voice and data communication. Most cellular communication in the world today utilizes either the Global System for Mobile Communications (GSM) or Code Division Multiple Access (CDMA) communication systems. These systems transmit voice data over a voice traffic channel using a modulated carrier wave, however, prior to modulating the voice data for wireless transmission, the voice input is run through a speech compression circuit to compress the voice input into a smaller amount of data. This reduces the amount of voice data that needs to be transmitted via the wireless network, thereby allowing a greater number of users to simultaneously share the same network. One example of an appropriate speech compression circuit is a vocoder, which compresses and/or encodes the speech before it is transmitted over the wireless network (transmitting side), and decompresses and/or decodes the wireless signal before playing it back (receiving side).

Another technique for more effectively utilizing the capacity of a wireless telecommunications network involves the assignment of a data rate at the beginning of a wireless transmission. For instance, at the beginning of a transmission over a Third Generation (3G) wireless network, a mobile station initiating a call requests a certain data rate or bandwidth by sending a signal representing a tone that indicates one of two different data rates (i.e.—a half tone for voice-only transmissions, and a full tone for voice and data transmissions). If all wireless transmissions were given the greater data rate associated with the full tone, then there would be a tremendous amount of wasted and unused bandwidth that would decrease the overall capacity of the wireless network.

### SUMMARY OF THE INVENTION

According to one aspect of the present invention, there is provided a method for configuring voice and data communication over a wireless telecommunications network that includes a cell tower, a network vocoder and a call center. The method generally comprises the steps of: (a) providing an onboard vehicle communications system having an antenna, a chipset with an onboard vocoder, a modem and a telephony device, (b) establishing a voice channel between the onboard and network vocoders over the wireless network where the voice channel is configured with a first data rate, (c) sending a message from the onboard vocoder to the network vocoder requesting a second data rate that is greater than the first data rate, and (d) altering the configuration of the voice channel so that voice and data transmissions can be sent according to the second data rate.

According to another aspect of the present invention, there is provided a method for configuring voice and data communication in a wireless telecommunications network that includes a base station having a network vocoder and a vehicle communications system having an onboard vocoder. The method comprises the steps of: (a) establishing a voice communication connection over the wireless telecommunications network between the base station and the vehicle communications system, (b) configuring the base station and the vehicle communications system to transmit over the voice communication connection at a first data rate that is selected by the base station, (c) sending a message from the vehicle communications system to the base station requesting a second data rate that is selected by the vehicle system and is greater than the first data rate, and (d) reconfiguring the base station and the vehicle communications system so that voice and data transmissions are sent over the voice communication connection at the second data rate.

According to yet another aspect of the present invention, there is provided a method for establishing a sufficient data rate for voice and data transmissions over a voice channel of a wireless telecommunications network. The method generally comprises the steps of: (a) utilizing a CDMA2000-compatible network vocoder, (b) utilizing a CDMA2000-compatible onboard vocoder, (c) participating in the configuration of a voice channel between the network and onboard vocoders where the configuration includes a first data rate whose selection is exclusively within the authority of the network vocoder, (d) sending a service option control message from the onboard vocoder to the network vocoder where the service option control message includes a request for a second data rate that is greater than the first data rate and whose selection is exclusively within the authority of the onboard vocoder, (e) participating in the modification of the voice channel which includes replacing the first data rate with the second data rate, and (f) sending voice and data transmissions over the voice channel according to the second data rate.

### BRIEF DESCRIPTION OF THE DRAWINGS

A preferred exemplary embodiment of the invention will hereinafter be described in conjunction with the appended drawings, wherein like designations denote like elements, and wherein:

FIG. 1 is a block diagram depicting an embodiment of a next generation wireless telecommunications network that has an EVRC-B vocoder and is capable of utilizing the present method;

FIG. 2 is a diagram of an embodiment of the present invention including steps involved in voice and data transmission over a voice channel of the wireless network of FIG. 1, and;

FIG. 3 is a table showing a number of exemplary data rates that can be used with the EVRC-B vocoder of FIG. 1.

### DETAILED DESCRIPTION OF THE PREFERRED EMBODIMENTS

The present method is intended for use with a wireless telecommunications network that incorporates a next generation vocoder or speech codec, such as an Enhanced Variable Rate Codec (EVRC-B) vocoder. Generally, the present method improves voice and data communication over a voice channel by enabling a mobile station, as opposed to a base station, to establish the transmission data rate for subsequent voice and data transmissions. In most next generation wireless networks, a component on the network side, such as a network vocoder incorporated within the base station, usually determines the data rate at the onset, and the selected data rate cannot be changed or altered by the mobile station. If the network component selects too low of a data rate, then subsequent voice and/or data transmissions can be prone to irrevocable errors. Therefore, the present method enables the mobile station, which in this case is an onboard vehicle communications system, to select a suitable data rate when the wireless transmission includes both voice and data over a voice channel.

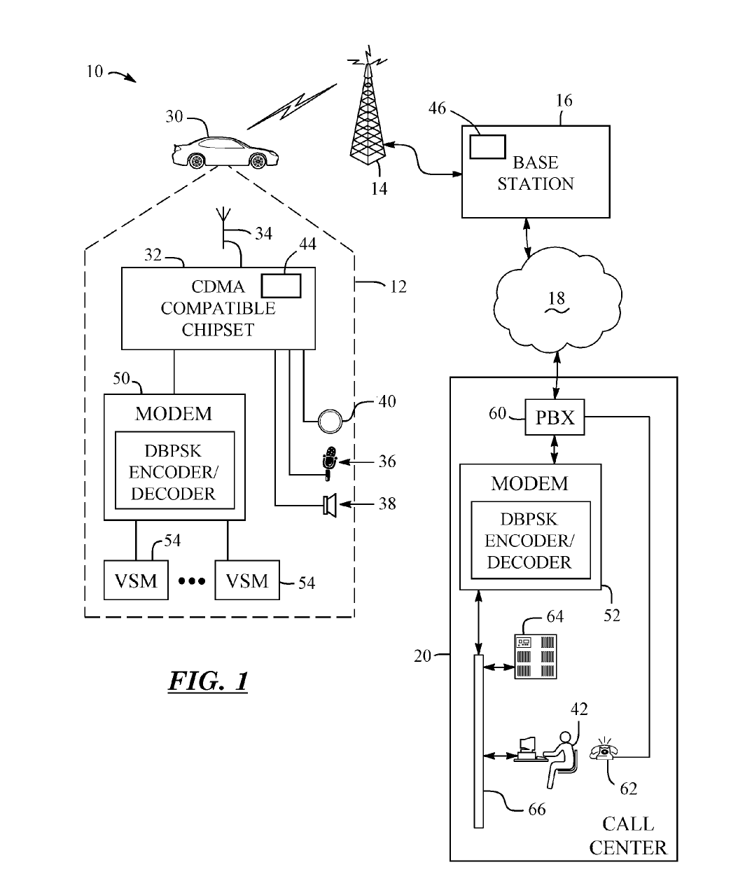

Referring to FIG. 1, there is shown an example of a wireless telecommunications network 10 that may be used with the present method. Wireless network 10 establishes a voice channel that is primarily used for two-way wireless voice transmission, such as that between cellular telephones, but can also be used to exchange data containing information other than speech. This data transmission over a voice channel can be carried out by using techniques such as, but certainly not limited to, Differential Binary Phase Shift Keying (DBPSK) modulation of an audio frequency carrier wave using the digital data. This approach enables data transmission via the same voice channel that is used for speech transmission and, with proper selection of carrier frequency and bit rate, permits the data transmission to be accomplished at a bit error rate that is acceptable for most applications. It should be appreciated that the overall structure, architecture and operation, as well as the individual components, of a wireless network such as that shown here are generally known in the art. Thus, the following paragraphs simply provide a brief overview of one such exemplary wireless network 10, however, other wireless networks not disclosed here could employ the present method as well.

According to the embodiment shown here, wireless network 10 establishes a voice channel for both voice and data transmission and generally includes an onboard vehicle communications system 12, a cell tower 14, a base station 16, a Public Switched Telephone Network (PSTN) 18, and a remote call center 20. Of course, wireless network 10 could include other components not shown here such as Mobile Switching Centers (MSCs), or it could include a plurality of the various network components that are shown (numerous cell towers, numerous base stations, etc.), to name but a few of the possibilities.

Onboard vehicle communications system 12 is preferably a mobile station that is installed in a vehicle 30 and is capable of receiving and transmitting both voice and data communications over a network voice channel. The onboard system 12 preferably includes components normally found in a cellular communication device, such as a CDMA compatible chipset 32 that includes an onboard vocoder 44 and is coupled to an antenna 34, which permit a vehicle occupant to carry on voice conversations using telephony devices such as microphone 36 and speaker 38. These components of onboard system 12 can be implemented in a conventional manner, as will be known to those skilled in the art. Onboard system 12 also includes a pushbutton 40 for enabling a vehicle occupant to initiate voice communication with a live advisor 42 or an automated voice response system located at call center 20.

In accordance with certain next generation wireless networks, voice data from both the vehicle occupant and call center 20 is encoded using speech codecs or vocoders 44, 46 that compress the speech prior to wireless transmission over the voice channel via cell tower 14. Once received over the wireless network, the encoded speech is then decompressed by a vocoder operating in the signal receive path. According to a preferred embodiment, a CDMA2000-compatible EVRC-B vocoder 44 is incorporated into chipset 32 (onboard vocoder) and a CDMA2000-compatible EVRC-B vocoder 46 is also incorporated into base station 16 (network vocoder). However, it should be appreciated that other next generation vocoders could be used as well. In fact, the present method may broadly be used with any wireless network where a CDMA2000-compatible network vocoder initially has exclusive control over the transmission data rate or bandwidth; that is, any wireless network where during the initial configuration of the voice channel, selection of the data rate is exclusively within the authority of the network vocoder.

In addition to the typical voice transmission, wireless network 10 enables data transmission via the same voice channel by passing the data through onboard and network vocoders 44, 46 incorporated into chipset 32 and base station 16, respectively. This is accomplished using a modem on either side of the vocoder; that is, using a first modem 50 incorporated into onboard system 12 and a second modem 52 located at call center 20. Because these modems can have the same construction and operation, only modem 50 will be described. It should be appreciated, however, that the description of modem 50 applies equally to modem 52. As shown in FIG. 1, modem 50 is coupled to the CDMA compatible chipset 32, which can be designed to switch or multiplex between the modem and telephony devices 36-38 so that the voice channel established by network 10 can be used for voice and/or data transmission, even during the same call. The transmitting modem uses a predefined tone or series of tones to alert the receiving modem of the requested data transmission, and the various parameters of the data connection can then be negotiated by the two modems 50, 52. In order to enable successful data transmission over the voice channel, the transmitting modem preferably applies a DBPSK modulation to convert the digital data so that it can communicate through vocoders 44, 46. Of course, any suitable encoding or modulation technique that provides an acceptable data rate and bit error rate, not just DBPSK encoding, can be used with the present method. For a more complete discussion pertaining to data transmission over a voice channel, please refer to U.S. patent application Ser. No. 11/163,579 filed Oct. 24, 2005, which is assigned to the present assignee and is hereby incorporated by reference.

On vehicle 30, the digital data being DBPSK encoded and processed by modem 50 can be obtained from one or more Vehicle System Modules (VSMs) 54 that are coupled to the chipset through the modem. These modules 54 can be any vehicle system for which data transmission is desired to or from call center 20 or any other remote device or computer system. For example, module 54 can be a diagnostic system that provides diagnostic-related codes and/or other trouble-shooting information to call center 20, or module 54 can be a GPS-enabled navigation system that uploads coordinates, position information or other navigation-related data to the call center. Conversely, data can also be transmitted from call center 20 (or other remote device or computer system) to the vehicle 30. For instance, where module 54 is a navigation system, new maps, turn-by-turn directions or point of interest information can be downloaded from the call center to the vehicle. As another example, module 54 can be an infotainment system in which music, podcasts, movies, television programs, videogames and/or other infotainment-related data can be downloaded and stored for later playback. Those skilled in the art will know of other such VSMs and other types of digital data for which communication to and from the vehicle 30 is possible, including electronic executable instructions.

Cell tower 14 is coupled to base station 16 and is designed to wirelessly communicate with the onboard system 12 of the vehicle. As is appreciated by those skilled in the art, various cell tower/base station/MSC arrangements are possible and could be used with wireless network 10. For instance, base station 16 could be co-located with cell tower 14 at the same site or it could be remotely located, and a single base station could be coupled to various cell towers or various base stations could be coupled to a single MSC (not shown), to name but a few of the possible arrangements. The speech codec or network vocoder 46 previously mentioned is preferably incorporated in base station 16, but depending on the particular architecture of the wireless network, could be incorporated within a Mobile Switching Center (MSC) or some other network component as well. The term “base station”, as it is used herein, broadly includes all of those components on the network side that are located between cell tower 14 and call center 20 and incorporate a speech codec or vocoder.

Call Center 20 is designed to provide a number of different system back-end functions and, according to the embodiment shown here, generally includes a live advisor 42, a modem 52, a Private Branch Exchange (PBX) switch 60, a telephone 62 and a server 64, most of which are coupled to one another via a network 66. The PBX switch 60 routes incoming calls; voice transmissions are sent to one or more telephones 62, while data transmissions are passed on to modem 52. The modem preferably includes a DBPSK encoder, as previously explained, and can be connected to various devices such as a server 64, which provides information services and data storage, as well as a computer used by the live advisor 42. These devices can either be connected to modem 52 via network 66 or alternatively, can be connected to a specific computer on which the modem is located. Although the illustrated embodiment has been described as it would be used in conjunction with a manned call center 20, it will be appreciated that the call center can be any central or remote facility, manned or unmanned, mobile or fixed, to or from which it is desirable to exchange voice and data.

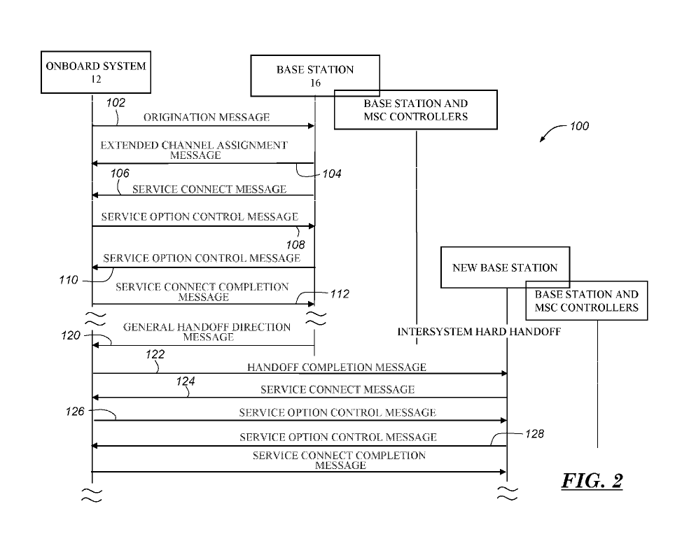

Turning now to FIG. 2, there is shown an embodiment 100 of the present method where onboard vehicle communications system 12 and call center 20 transmit both voice and data information over a voice channel that is established and maintained by wireless network 10. Beginning with step 102, a call is first initiated by either the onboard system 12 or call center 20; in this particular example, onboard vocoder 44 initiates configuration of a voice channel by transmitting an origination message to network vocoder 46, which is essentially a request by the onboard system to place a wireless call over the network. The origination message is preferably sent through a CDMA layer three access channel and conveys several pieces of information to the base station, including an identification of the onboard system 12, the dialed number, and service option information that can be used by the network to serve the origination call. The origination message can include other content as well. The service option information is defined in the CDMA standard and identifies the type of onboard vocoder being used by onboard system 12 so that network 10 can effectively communicate with the onboard system. Optionally, the onboard vocoder can also use the origination message to propose an initial service configuration to the network vocoder, which includes many of the common attributes used to configure and build traffic channel frames.

Once the origination call is processed by network vocoder 46, it continues the voice channel configuration process by assigning a traffic channel and transmitting an extended channel assignment message to onboard vocoder 44, step 104. The extended channel assignment message is preferably sent through a CDMA layer three paging channel and generally includes a service option number and the service configuration information, including the assigned traffic channel on which the subsequent transmission will take place. The service option number uniquely identifies a particular service option (for instance, service option number ‘68’ indicates that an EVRC-B connection is being requested) and allows various voice and non-voice services to be defined and specified independently within the confines of the physical layer and the multiplex sub-layer interface. The service configuration information should indicate whether or not network 10 supports the onboard vocoder type previously identified in the origination message.

At some time following transmission of the extended channel assignment message, network vocoder 46 sends onboard vocoder 44 a service connect message over the CDMA layer three forward traffic channel previously selected and identified, step 106. If onboard system 12 previously proposed an initial service configuration, then base station 16 can use the service connect message to either accept or reject that proposal. In either case, the service connect message preferably instructs onboard system 12 to begin communicating using the established service configuration. It should be pointed out that the voice channel is initially configured with a first data rate that is selected by network vocoder 46 and is preferably conveyed to onboard vocoder 44 through either the extended channel assignment message or the service connect message. In most next-generation wireless networks, selection of this first or initial data rate is exclusively within the authority of the network vocoder.

According to step 108 in FIG. 2, a service option control message is sent over a CDMA layer three forward traffic channel by onboard system 12 to base station 16 following the service connect message. The service option control message is primarily sent for the purpose of establishing a second, greater data rate that replaces the first data rate previously established by network vocoder 46. In most next generation wireless systems, a mobile station such as onboard system 12 is not able to establish a data rate, as that operational parameter is wholly within the purview of a network component such as the network vocoder. For most voice transmissions carried out between cellular handsets and the network, this is not much of a concern because the data rate selected by the network component is typically sufficient to handle speech and other audible transmissions. In the present method, however, where both voice and data transmissions are being conveyed over a voice communication connection, an insufficient data rate or bandwidth can present problems. This is particularly true in instances where large amounts of data are being transmitted.

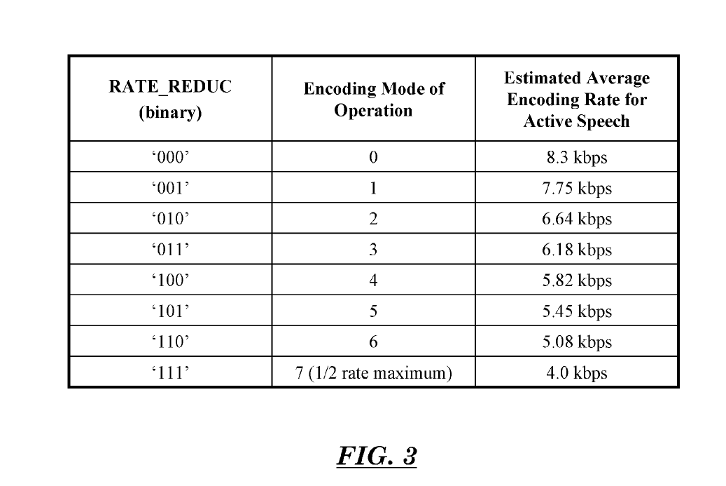

Referring now to FIG. 3, there is shown a table containing eight different data rate settings for most CDMA2000-compatible EVRC-B vocoders. The eight binary RATE_REDUC values (‘000’-‘111’) correspond to various data rates (8.3 kbs-4.0 kbs) and, depending on the RATE_REDUC value chosen, dictate the data rate or bandwidth for the voice and data transmissions over the network voice channel. According to a preferred embodiment, the onboard vocoder 44 selects the highest data rate (“000”=8.3 kbs), sometimes referred to as operating point zero (OPO), and indicates this selection by populating the data rate field of the service option control message with a ‘000’. This data rate selection by the onboard vocoder trumps any conflicting selection previously made by the network vocoder, as the onboard vocoder has exclusive authority to select the second data rate. Of course, it is possible for onboard vocoder 44 to select one of the other possible data rates, if such a data rate more accurately reflects the needs of that particular transmission.

It should be appreciated that the data rate field is just one of numerous fields contained within the service option control message, and that one or more other fields could be populated with default values (including zero or no value at all) or selected values. Even though the service option control message of FIG. 2 is shown being transmitted after the service connect message and before a second service option control message sent by network vocoder 46, this particular order of messages is only one possible sequence, as service option control message 108 can be sent at any time after the point when a voice channel has been established between the onboard and network vocoders. For example, the onboard vocoder 44 could send a service option control message 108 requesting a higher data rate at a much later time, even after a service connect completion message 112 and during the middle of a typical cellular call. According to a preferred embodiment, the service option control message 108 is sent after the service connect message 106 and before a service connect completion message 112, but this is not necessary. If a service option control message 108 is sent by onboard system 12 at a later time, such as during the course of normal voice transmissions, then network vocoder 46 preferably responds with some type of confirmation message indicating that it is upgrading the data rate of the voice channel transmissions.

Turning back now to FIG. 2, network vocoder 46 preferably responds to the service option control message 108 by increasing the data rate and sending a reply service option control message, step 110. This second service option control message can be used as a confirmation by the network vocoder that the voice channel has been altered or upgraded to the greater data rate requested by the onboard vocoder, or it can simply be a dummy message that is ignored by onboard vocoder 44. As a last handshaking message to be transmitted before commencement of normal use of the voice channel, onboard vocoder 44 sends a service connect completion message, step 112, to network vocoder 46 over a CDMA layer three reverse traffic channel. In general, the service connect completion message acknowledges any previous changes to the service configuration. It should be appreciated that numerous messages are sent between onboard system 12 and base station 16 during this initial communications phase, and that the origination, extended channel assignment, service connect, service option control and service connect completion messages discussed above are only some of the communications sent over the wireless network.

After the service connect completion message, onboard system 12 and call center 20 can begin their voice and data transmissions over the network voice channel. This service configuration continues until the call is either terminated or a handoff (soft or hard) occurs. A handoff is generally an uninterrupted transfer of control of a cellular phone call from a first base station located in a first cell to a second base station located in a second cell, and it generally comes in two forms: a soft handoff and a hard handoff. According to a soft handoff (not shown in FIG. 2), which is a CDMA feature, two base stations (one in the cell where the mobile station is located and one in the cell to which the call is being passed) both hold onto the call until the handoff is completed. Put differently, the first base station does not drop the call until it receives information that the second base station is maintaining the call. In the case of a hard handoff, which generally follows step 112 in FIG. 2, only one base station at a time carries the cellular call as the mobile station moves from one cell to another. This type of handoff is more common in networks that use standards such as GSM and GPRS, and in scenarios where a mobile station moves between the networks of two different CDMA-based wireless providers.

According to the present method, if a handoff occurs (either soft or hard) between two base stations using the same vocoder (for instance, if two base stations are connected to a common MSC where the vocoder is incorporated), then there is no need to reestablish the operating point zero data rate as that vocoder is already aware of the higher requested bandwidth. If the handoff occurs between base stations using separate vocoders, then the onboard vocoder will generally need to reestablish the data rate with the new network vocoder. This method is generally depicted in FIG. 2, where in step 120 the old network vocoder 46 sends onboard vocoder 44 a general handoff direction message on a CDMA layer three forward traffic channel. The general handoff direction message can convey several pieces of information, including which type of negotiation (service negotiation or service option negotiation) is to be used following a CDMA-to-CDMA hard handoff. This message can also accept a service configuration previously proposed by onboard vocoder 44 or it can instruct the onboard system to begin using a new service configuration.

In response, the onboard vocoder 44 preferably sends a handoff completion message to the new network vocoder over a CDMA layer three reverse traffic channel, step 122. The handoff completion message is preferably sent to the new network vocoder once the inter-base station handoff is complete using the service configuration provided in the handoff direction message. As with the previous sequence of steps, a service connect message is then sent by the new network vocoder (step 124), a first service option control message is sent by the onboard vocoder (step 126), the new network vocoder responds with a second service option control message (step 128), and finally the onboard vocoder transmits a service connect completion message (step 130). Like before, the first service option control message sent by onboard vocoder 44 preferably includes a data rate field in which the highest data rate (operating point zero) is selected. The reason for sending this increased data rate request again (it was previously sent in step 108) is because the new vocoder is generally unaware of the requested increase in bandwidth. A general explanation of these messages was provide above, thus, a second duplicate explanation here has been omitted.

It is to be understood that the foregoing description is not a description of the invention itself, but of one or more preferred exemplary embodiments of the invention. The invention is not limited to the particular embodiment(s) disclosed herein, but rather is defined solely by the claims below. For example, the method of configuring voice and data communication described above could be used with one of a number of other networks and is not specifically limited to the wireless network 10 that is shown in FIG. 1. Even though the present method is described above in the context of both voice and data transmissions over a voice channel, it is possible to apply the present method to only data transmissions occurring over a voice channel. Furthermore, the method outlined in FIG. 2 could be initiated by a page response message sent by network vocoder 46, as opposed to the origination message sent by onboard vocoder 44. It will be appreciated by those skilled in the art that in such a scenario, the onboard vocoder can still send a service option control message to the network vocoder to establish a second, higher data rate.

The statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example”, “for instance” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. A method for configuring voice and data communication over a wireless telecommunications network that includes a cell tower, a network vocoder and a call center, comprising the steps of:
(a) providing an onboard vehicle communications system having an antenna, a chipset with an onboard vocoder, a modem and a telephony device, the modem provides for data transmissions and is coupled to the chipset for communication through the onboard vocoder, the telephony device provides for voice transmissions and is also coupled to the chipset for communication through the onboard vocoder, and the antenna provides for voice and data transmissions to the cell tower and is coupled to the chipset;
(b) establishing a voice channel between the onboard vocoder and the network vocoder over the wireless network, and the voice channel is configured with a first data rate that is selected by the network vocoder;
(c) sending a message from the onboard vocoder to the network vocoder requesting a second data rate that is selected by the onboard vocoder and is greater than the first data rate, and;
(d) altering the configuration of the voice channel so that voice and data transmissions can be sent between the onboard system and the call center according to the second data rate.

2. The method of claim 1, wherein each of the network and onboard vocoders is a CDMA2000-compatible vocoder, and the network vocoder has exclusive control over selecting the first data rate.

3. The method of claim 2, wherein each of the network and onboard vocoders is an EVRC-B vocoder.

4. The method of claim 1, wherein during said step (b) the onboard vocoder initiates the establishment of the voice channel by sending an origination message to the network vocoder.

5. The method of claim 1, wherein during said step (b) the network vocoder initiates the establishment of the voice channel by sending a page response message to the onboard vocoder.

6. The method of claim 1, wherein during said step (b) the first data rate is established by the network vocoder in either an extended channel assignment message or a service connect message.

7. The method of claim 1, wherein during said step (c) the second data rate is established by the onboard vocoder in a service option control message.

8. The method of claim 7, wherein the service option control message includes a data rate field that the onboard vocoder uses to select the highest possible data rate (operating point zero).

9. The method of claim 8, wherein the service option control message includes a plurality of fields other than the data rate field, and the onboard vocoder populates the plurality of fields with default values or selected values.

10. The method of claim 7, wherein the service option control message is sent by the onboard vocoder after a traffic channel has been established by the network vocoder.

11. The method of claim 10, wherein the service option control message is sent after the network vocoder sends a service connect message and before the onboard vocoder sends a service connect completion message.

12. The method of claim 1, wherein during said step (a) the modem applies a Differential Binary Phase Shift Keying (DBPSK) modulation to the data transmissions for communication through the onboard vocoder.

13. The method of claim 1, wherein during said step (a) the onboard vehicle communications system further includes a Vehicle System Module (VSM), and the VSM provides diagnostic-related, navigation-related or infotainment-related data and is coupled to the chipset for communication through the onboard vocoder.

14. The method of claim 1, wherein the network vocoder is incorporated within a base station that is coupled to the cell tower.

15. The method of claim 1, further comprising the step:
(e) sending an additional message from the onboard vocoder to a new network vocoder reestablishing the second data rate, in the event that a handoff occurs between the network vocoder and the new network vocoder.

16. The method of claim 15, wherein during said step (e) the second data rate is reestablished by the onboard vocoder in a service option control message.

17. The method of claim 1, wherein during a handoff that does not involve a new network vocoder, the onboard vocoder does not send an additional message to the network vocoder reestablishing the second data rate.

18. A method for configuring voice and data communication in a wireless telecommunications network that includes a base station having a network vocoder and a vehicle communications system having an onboard vocoder, the method comprising the steps of:
(a) establishing a voice communication connection over the wireless telecommunications network between the base station and the vehicle communications system;
(b) configuring the base station and the vehicle communications system to transmit over the voice communication connection at a first data rate that is selected by the base station;
(c) sending a message from the vehicle communications system to the base station requesting a second data rate that is selected by the vehicle system and is greater than the first data rate; and
(d) reconfiguring the base station and the vehicle communications system so that voice and data transmissions are sent over the voice communication connection between the base station and the vehicle system at the second data rate.

19. A method for establishing a sufficient data rate for voice and data transmissions over a voice channel of a wireless telecommunications network, comprising the steps of:
(a) utilizing a CDMA2000-compatible network vocoder;
(b) utilizing a CDMA2000-compatible onboard vocoder that is in wireless communication with the network vocoder;
(c) participating in the configuration of a voice channel between the network and onboard vocoders over the wireless network, where the voice channel configuration includes a first data rate whose selection is exclusively within the authority of the network vocoder;
(d) sending a service option control message from the onboard vocoder to the network vocoder over the wireless network, where the service option control message includes a request for a second data rate that is greater than the first data rate and whose selection is exclusively within the authority of the onboard vocoder;
(e) participating in the modification of the voice channel between the network and onboard vocoders, where the voice channel modification includes replacing the first data rate with the second data rate, and;
(f) sending voice and data transmissions over the voice channel between the network and onboard vocoders according to the second data rate.
